(19) United States
(12) Patent Application Publication
(10) Pub. No.: US 2014/0299468 A1
(43) Pub. Date: Oct. 9, 2014

(54) High-Performance Analytical Instrument and Method

(71) Applicant: Hongjun Yang, Derwood, MD (US)

(72) Inventor: Hongjun Yang, Derwood, MD (US)

(21) Appl. No.: 14/309,896

(22) Filed: Jun. 20, 2014

Related U.S. Application Data
(63) Continuation-in-part of application No. 13/532,772, filed on Jun. 25, 2012.

(51) Int. Cl. G01N 27/327; G01N 21/76

(52) U.S. Cl. CPC G01N 27/327; G01N 21/76
USPC 204/403.15; 204/412

(57) ABSTRACT

Apparatus and methods are provided for improving sensitivity, throughput, and efficiency of multi-analyte analytical testing. Specifically, an improved Electrochemiluminescence (ECL) analytical apparatus is provided for analytical chemistry, diagnostics, and environmental applications. The ECL apparatus comprises a 96 or more-well plate, where a microarray of working electrodes is placed in each well for high throughput and multi-analyte testing. The microarray of working electrodes connects with a counter electrode forming a two-electrode electrochemical system. Each well is electrically addressable, thereby controlling ECL reactions in flexible modes. The ECL apparatus further comprises a detector of ECL signals, and the detector employs a CCD-chip assembling matrix. Also provided are methods for high-throughput multi-analyte testing. The methods according to this disclosure are applied in various embodiments to test a broad range of analytes, including chemical compounds, proteins, peptides, DNAs, RNAs, antigens, antibodies, pathogens, contaminants, and derivatives thereof.

### BACKGROUND OF THE DISCLOSURE

This application is a continuation-in-part of, and claims the priority benefit from, U.S. patent application Ser. No. 13/532,772, filed Jun. 25, 2012, entitled “High Performance Diagnostic Instrument and Method.”

The present disclosure relates in general to analytical instruments and methods for mutli-analyte analytical testing. Specifically, the present disclosure relates to electrochemiluminescent (ECL) multi-analyte testing. More specifically, apparatus and methods are provided for improving throughput, sensitivity, and efficiency of ECL testing. The disclosed apparatus employs a multi-well plate, where a microarray of working electrodes is placed in each well for high throughput multi-analyte testing. The microarray of working electrodes connects with a counter electrode forming a two-electrode electrochemical system. Each well is electrically addressable, thereby controlling ECL reactions in flexible modes. Methods are provided utilizing the apparatus disclosed herein for applications of clinical diagnostics, non-clinical analysis, bio-agricultural applications, disease control, and environmental testing.

Many analytical techniques have been utilized in diagnostic applications and general laboratory testing. These techniques include radioactive labeling, enzyme linked Enzyme-linked immunosorbent assay (ELISA), chemical colorimetric assays, fluorescence labeling, chemiluminescent labeling, and electrochemiluminescent labeling. Each of these techniques has its different strength and weakness, which define as well as limit its utility in different diagnostic and other applications. These differences are in part due to physical constraints inherent to each technique. Radioactive labeling, for example, is inherently problematic because the disposal of the labeling materials results in radioactive waste, which can have a negative impact on the safety and environmental cost for many applications.

Electrochemiluminescence (ECL) has been developed as a powerful signal detection method and widely applied in diagnostics in the past two decades. ECL has many advantages over other signal detection methodologies, including, for example, fluorescence and chemiluminescence. These advantages include low background, high sensitivity, wide dynamic range, good reproducibility, and the ease of use. Since the first diagnostic instrument based on ECL was published in early 1990s', ECL detection has been proven as a powerful tool in the field. See, Hongjun Yang, John Leland, David Yost and Richard J. Massey, “Electrochemiluminescence, New Highly Sensitive Diagnostic Technology”, Nature, Biotechnology, 12 (1994) 193-194; Hongjun Yang and John Leland, “New Development and Applications of Electrochemiluminescence”, in “1994 McGraw-Hill Yearbook of Sciences & Technology”, pp. 75-77, McGraw-Hill Publish Co., New York (1993).

The ECL concept has been successfully applied to a bipolar electrode system within a microfluidic channel using one- or two-compartment cell containing one, two, or three electrodes in early 2000's. See, e.g., Wei Zhan, Julio Alvarez and Richard M. Crooks, “Electrochemical Sensing in Microfluidic System Using Electrogenerated Chemiluminescence as a Photonic Reporter of Redox Reactions”, J. Am. Chem. Soc., 124 (2002) 13265-13270; Wei Zhan, Julio Alvarez and Richard M. Crooks, “A Two-Channel Microfluidic Sensor That Uses Anodic Electrogenerated Chemiluminescence as a Photonic Reporter of Cathodic Redox Reactions”, Anal. Chem., 75 (2003) 313-318.; Wei Zhan, Julio Alvarez and Richard M. Crooks, “A Multi-Channel Microfluidic Sensor That Detects Anodic Redox Reactions Indirectly Using Anodic Electrogenerated Chemiluminescence”, Anal. Chem., 75 (2003) 1233-1238. Traditionally, an electrochemical cell is composed of three electrodes: a working electrode, a counter electrode, and a reference electrode. The reference electrode usually is in its equilibrium state and has a high resistance, and has its intrinsic electrode potential. It is usually connected to the ground. If the reference electrode were eliminated, the resulting two electrode system could work while there is no “electrode potential,” only a voltage between two electrodes.

Although ECL has been shown to be an effective signal detection platform, existing instruments generally rely on single cell and single electrode detection format, which has limited throughput. Some improvement has been made recently by converting single cell mode to 96-well mode, however, the commercialization of nano-materials required for such improvement created certain problem. There is thus a need for further improvements.

Therefore, in general, diagnostics and other analytical applications which simplify testing procedures, improve throughput, and decrease cost per test would be of great importance and utility in enhancing the performance in existing market and in opening new markets.

### SUMMARY OF THE VARIOUS EMBODIMENTS

It is therefore an object of this disclosure to provide systems and methods for improving sensitivity, throughput, and efficiency of analytical testing, including clinical diagnostics and general laboratory testing. Particularly, in accordance with this disclosure, there is provided, in one embodiment, a high-sensitivity, high-throughput, and high-efficiency ECL analytical apparatus.

The ECL apparatus of this disclosure combines microarray with a multi-well plate. A 96 or more-well plate is used in one embodiment. A microarray of working electrodes is placed in each well according to one embodiment, thereby a high throughput and multi-analyte testing is performed. According to another embodiment, this microarray of working electrodes forms a two-electrode electrochemical system with a counter electrode. In yet another embodiment, each well is electrically addressable, thereby controlling ECL reactions in flexible modes. According to a further embodiment, carbon paste is employed for the detection plate as one of the electrode material, electric contact material, and print circuit material.

According to another embodiment, the ECL apparatus replaces photomultiplier tubes (PMT) with a charge-coupled device (CCD)-based detection system. In one embodiment, a CCD-chip assembling matrix is used for detection. According to another embodiment, a proximity detecting method is used and no other optical tools are necessary. In a further embodiment, the ECL apparatus further comprises a fluidic handling system for labeling, washing and related steps. In another embodiment, the ECL apparatus further comprises a data management system for reporting and analyzing ECL signal data.

The ECL apparatus according to this disclosure therefore provides high sensitivity, a dynamic range, supports high-throughput, and facilitates data management. It is also highly efficient based on cost per test.

Thus the ECL apparatus of this disclosure provides significant advantages to diagnostics applications in clinical and research laboratories and other related applications in various analytical settings. In further embodiments, there are provided herein related diagnostics methods and applications using the aforementioned apparatus

In additional embodiments, the ECL apparatus of this disclosure is used to analyze peptides, proteins, DNAs, RNAs, antibodies, antigens, small molecules, pathogens, contaminants, and other chemical, biological compounds. In another embodiment, ECL is applied to personalized medicine or for early diagnosis of human diseases, where the detection of specific DNA and RNA molecules is the focus. DNA/RNA probes are designed and made for such DNA/RNA-related tests and work under applicable surface attachment chemistry.

### BRIEF DESCRIPTION OF THE DRAWINGS

FIG. 1 depicts a two-dimensional display according to one embodiment of this disclosure.

FIG. 2 depicts two electrodes system at a single well and their electric connections according to another embodiment.

FIG. 3 depicts a multi working electrode array and a counter electrode at a single well according to another embodiment.

FIG. 4 depicts the top view of the bottom plate of a 96-well plate according to one embodiment. The solid lines are printed in the front of the plate and refer to the An′-Bn′ connections. The dash lines are printed in the back of the plate refer to An″-Bn″ connections.

FIG. 5 depicts how two sides of the bottom plate are connected electronically according to one embodiment.

FIG. 6 depicts a fluidic handling system according to one embodiment of this disclosure.

### DETAIL DESCRIPTION OF THE VARIOUS EMBODIMENTS

### Analytical Apparatus

A key component of the ECL apparatus according to this disclosure is a multi-well plate. The design and fabrication of a 96 or more-well plate according to one embodiment is described below. In another embodiment, the ECL apparatus further comprises a detector, for detecting ECL signals. In yet another embodiment, the ECL apparatus further comprises a data management system for reporting and analyzing signal data from the detector. In an additional embodiment, the ECL apparatus further comprises a fluidic handling system for labeling, washing, and supplying and dispose of buffer and sample solutions.

1. Multi-Well Plate

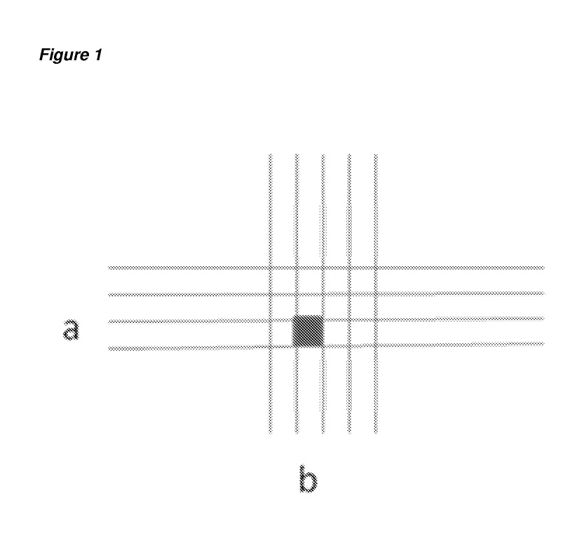

FIG. 1 illustrates the electric connection of a two-dimensional display matrix. Referring to this figure, in order to light up the pixel at position (a, b), both row a and column b are turned on simultaneously. That is, a single pixel can be lit up only when 2-dimensional connections both are on. A one-dimensional contact cannot light up a pixel.

The two-dimensional connection shown here can be made by a set of two-dimensional physical contacts and can be controlled by a computer software, hardware, or firmware.

For a multi-well plate, such as a 96-well or over 96-well plate according to various embodiments, the working electrode and counter electrode are turned on simultaneously at each particular well to perform the ECL reaction. Thus, two sets of two-dimensional connections are simultaneously turned on.

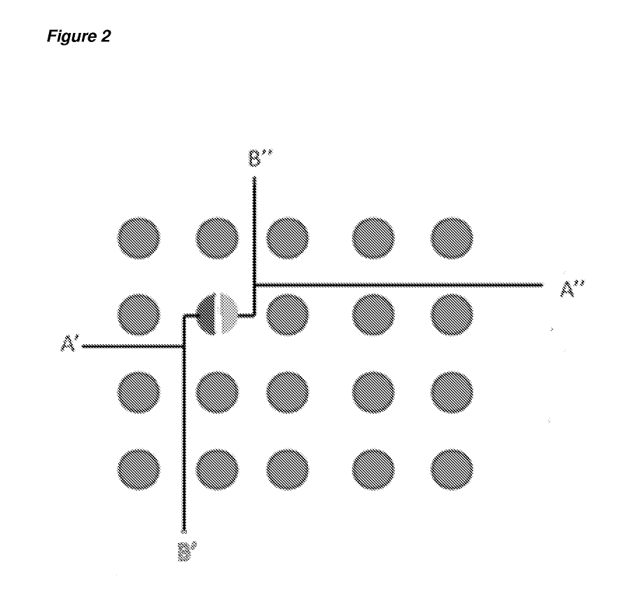

Referring to FIG. 2, two electrodes, the working electrode and the counter electrode, are at a single well. They have A′B′ and A″B″ connections, respectively. The working electrodes at the same column may share one contact lead; the counter electrodes at the same row may share one contact lead. Thus, the entire plate may only need 40 contact leads: 8 for A′ type; 12 for B′ type; 8 for A″ type; 12 for B″ type. All these contact leads may be made on the side of the 96-well plate in one embodiment. They may be controlled by a computer, including one of software, hardware, and firmware. Such a two-dimensional electric contact configuration also provides the flexibility in various embodiments to review, compare, and analyze a single well, a 2×2 matrix, a 3×3 matrix, or a 4×4 matrix simultaneously by manipulating the control of the contacts. To achieve high resolution, the maximum matrix of wells according to one embodiment is 4×4. In that embodiment, therefore, the reading of the entire plate may be completed with six times. Accordingly, the throughput may be improved according to one embodiment by a factor of 16.

Under a high throughput configuration, when a two electrode system is utilized according to one embodiment of this disclosure, the voltage is applied to the electrodes in parallel, while the current is measured in a series mode. Therefore, the measurement of the current may be obtained as the optimized ECL signal at a single well. Based on the value of this current, the value of the resistance (RΩ) in serial setting can be obtained. Accordingly, for a 2×2 well matrix, R/4Ω should be used in the setting. And R/16Ω and R/16Ω should be used in the setting for a 3×3 and a 4×4 matrix, respectively.

In an alternative embodiment, a multi-target test may be carried out at a single well. According to this embodiment, a multi-electrode array is placed in a single well. Here, for example, a 4-electrode array may be utilized in one embodiment. While a 4-electrode array is placed in the bottom of the well, each electrode may be addressed similarly as described above. However, the electric circuitry in this embodiment may be more complex and may result in increased cost.

Yet, in other embodiments, it is not necessary for a single electrode to be addressed independently and a single electrode is not addressed independently. When an array is placed in the well, a multi-parameter ECL test is expected. To compare the ECL signals from each electrode, each electrode must operate under the same working conditions and environment. Thus, it is desirable to place the electrode array under the same conditions. Accordingly, each electrode are applied with the same voltage, and current is also uniformly distributed to each electrode. This way, the ECL signals generated at each electrode may be comparable. Therefore, 4 working electrodes may be set in parallel according to another embodiment, where only one lead is utilized. The aforementioned 40 electric contact leads configuration may be used for testing in this embodiment. For larger numbers of testing, the number of electrodes in the well may be increased accordingly in further embodiments.

According to one embodiment of this invention, the carbon paste for the working electrodes and the counter electrode are different. In a particular embodiment, the carbon paste for the working electrodes is mixed or combined with a certain concentration of streptavidin. This streptavidin-treated carbon paste is formed or processed according to one embodiment by mixing in and/or combining with a streptavidin solution. When carbon paste printed on the bottom of 96-well plate was dried, the streptavidin would be firmly immobilized on the working electrodes surfaces

According to various embodiments, the carbon paste for the working electrodes comprises about 1-10% streptavidin by weight. According to a particular embodiment, the carbon paste for the working electrodes comprises about 5% streptavidin by weight. The streptavidin mixed in the carbon paste for the working electrodes according to these embodiments provides linking chemistry to capture antibodies or DNA probes that are modified or treated with biotin. Other similar chemistry and immobilization methods known to the ordinary skilled scientists may be employed in alternative embodiments.

By comparison, according to one embodiment, the carbon paste for counter electrodes is not treated with streptavidin and comprises no streptavidin.

The differentiated carbon-paste working and counter electrodes according to certain embodiments of this invention provide a new, reliable, and cost-efficient way to support multiplex ECL systems of this invention. The concentration of streptavidin in the carbon paste for the working electrodes is about 1-10% and may be adjusted and fine-tuned according to various embodiment based on the antibodies, DNA probes of interest for specific different tests or experiments.

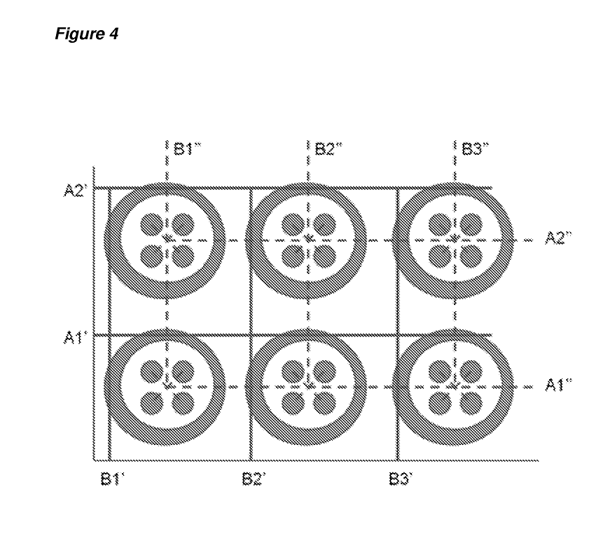

Referring to FIG. 4, a 4 working electrode array and a counter electrode are shown at a single well. In this embodiment, a ring electrode is used as a counter electrode. Its area is larger than the sum of areas of the 4 working electrodes in the other embodiment. This increased contact area helps to ensure that the best possible ECL signals may be obtained, hence improved sensitivity. In further embodiments, more working electrodes may be added to the array so long as there is space available. The optimal numbers of electrodes may be determined in various embodiments for the ECL apparatus based on the level of sensitivity and desirable throughput, balanced against the manufacturing cost.

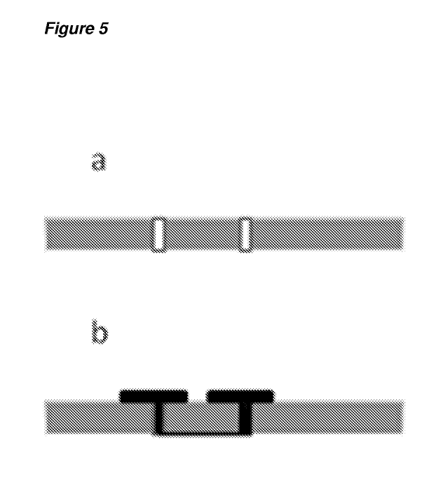

Referring to FIG. 5, according to one embodiment two sides of the bottom plate are connected electronically. Before printing the carbon paste, a hole is drawn at the center of an electrode. After printing the carbon paste, two sides are connected electronically by the carbon paste.

In one embodiment, all An′ contact leads are on left side edge. All Bn′ contact leads are on down side edge. All Bn″ and An″ contact leads are on the right side and up side edges, respectively. In such an arrangement, An′-Bn′ contact leads cannot be contacted cross An″-Bn″ contact leads because they were on different faces of the plate. Therefore, although a multi-working electrode array is placed in a well, it operates as a 2-electrode system from the standpoint of electric contact. However, from the view of a test assay, this electrode array is still very significant. Different DNA probes or capture antibodies could be modified with biotin, then further immobilized on the different spots via streptavidin-biotin conjugation, i.e., at the different electrode surfaces. In alternative embodiments, therefore, a multi-target test can be conducted at a single well simultaneously. Specially, each well may select one of the electrodes as an internal reference in one embodiment. This is very important for analytical purpose. Assuming one particular DNA probe is designed and immobilized on one electrode surface. Then its complementary strand whose concentration is known may be spiking in the post-PCR target solution mixture. After hybridization and ECL measurement, this ECL signal may be a reference for quantitative analysis of other unknown DNA targets.

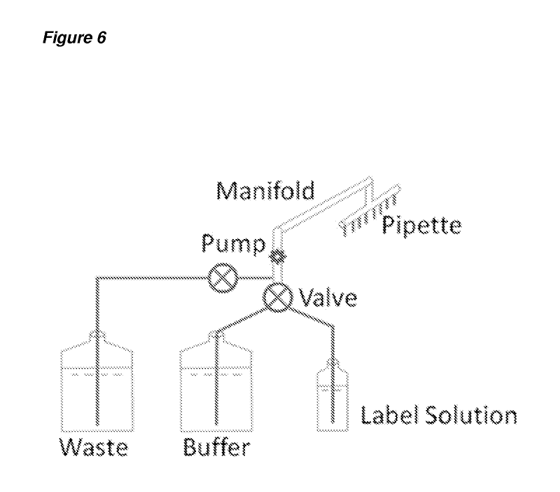

All electrodes and contact circuitry may be made by printing carbon paste in one embodiment. According to one embodiment, the carbon paste for connection purposes does not mix with streptavidin. This is an inexpensive but efficient method for manufacturing a multi-well or 96-well plate. FIG. 6 shows a cross section of the bottom plate. As shown in a), before printing a tiny hole is drawn at the centers of each working electrodes. These holes also may be made by pre-casting. After the printing, the carbon paste may fill the hole with the capillary phenomenon. As the paste dry out, a solid printing circuit board, i.e., the bottom plate of a 96-well plate is made.

After the printing electrodes and contact circuitry, the surface modification, DNA probe or antibody immobilization, and other applicable modification may be performed. Then, the multi-well (96 or more-well) plates may be assembled.

2. Detector

Since two-dimensional images are taken, a sensitive CCD camera can be used. Relevant software programs and firmware may be utilized in various embodiments to analyze the images and data.

As a result of recent development in semiconductor industry, an advanced CMOS technology has been applied to improve the sensitivity of CCD camera to a level comparable to that of PMT, with low noise level, high resolution, high speed read-out, and high dynamic range (4500:1). See, ORCA®-Flash 2.8 Digital Camera, Hamamatsu Product Catalogue 2010 (Cat. No. SCAS007E01).

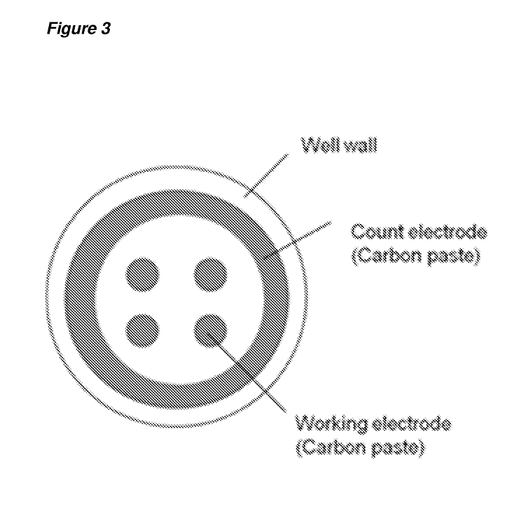

Beside the nature of CCD chip material, the CCD working environment is also relevant. For low light detection, the shorter of the distance between CCD and the object, the better the image obtained. On the other hand, the size of the CCD chip is another critical issue in terms of applications and the cost of instrument. For certain size of CCD chip, the shorter distance, the smaller area of the imaging object. If the entire 96-well plate is imaged, the CCD chip size should be similar to the plate size so that the distance between camera and object could be quite short, i.e., the proximity detection is reached. However, such a big size CCD is practically impossible. Referring to FIGS. 3 and 4, the actual imaging area of a well is the area that just covers 4 working electrodes. That area is only a small portion of the well. Therefore, according to one embodiment, the CCD detector is designed to maximize the usage of CCD chip.

In one embodiment, the detector may be assembled as a 2×2 CCD matrix with 4 small CCD chips. Each CCD of the matrix could reach inside of a well. Thus the use of such a CCD matrix could cut the cost down without any compromising of the sensitivity of the detection.

Such a CCD matrix can be extended to a larger size, e.g., 4×4 matrix. If 4×4 CCD matrix is used, the 96-well plate only needs imaging 6 times. This CCD matrix is also flexible. If only one well needs to be imaged, then one CCD of the matrix needs to be turned on. Others may be turned off.

Considering the photo efficiency, the optical tools are avoided since the proximity detection is taken.

In alternative embodiments, this instrument is also feasible for chemiluminescence detection in general. With liquid handling tool equipped in the system, the labeling reagents are the only components that need to be replenished or changed in for each 96-well plate.

3. Fluidic Handling

The ECL apparatus has a fluidic handling system that may be semi-automated in one embodiment. This fluidic system is sufficient to perform labeling, washing and related steps. The biologic binding reactions can be performed outside of the instrument. In another word, either antibody-antigen sandwich or DNA hybrid is formed already before the 96-well plate entering into the instrument. Thus, the fluidic handling should be relatively simple. FIG. 6 describes the fluidic system in one embodiment. The pump may work in two ways: the buffer or label could be pumped into each well via manifold and pipette; it could be also pumped out from wells to the waste.

4. Data Management

The ECL apparatus comprises a data management system in one embodiment. The data management can be a software, firmware or hardware system in various embodiment. In one embodiment, each part, each motion may be controlled by the software program while keeping the operation more interactive between the operator and the instrument.

The ECL apparatus can also include a wireless data communication capacity so that the results of measurements can be communicated with a central lab or data management center. This is important for the prompt diagnosis of diseases and therapeutic treatments.

Overall, for mechanical design, this instrument should have these functional modules: (1) The 96-well plate moves in and out; (2) The plate of (1) can perform vortex motion; (3) Fluidic handling; (4) CCD camera to record photonic images emitted from the plate of (1).

### Labeling and Assays

The labeling process is another important element for ECL measurement. The label molecule is the derivatives of Ru(bpy)32+, usually is an —NHS-ester that is easily linked with an amino-group of a known sequence DNA probe or antibody. This label molecule has the chemical structure as following:

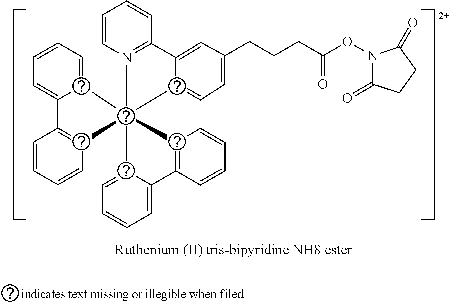

Then this labeled probe (or antibody) is hybridized with amplified sample solution.

Considering a multi-target test at a well, the targets are multiple so that the PCR reaction or other amplification must be multiplex reactions. However, the labeled probe molecule is of one sequence. Therefore, this sequence should be considered in the design of amplification process.

For DNA probe assay applications, if a sandwich assay format is used, this label can be linked with an amino-group modified poly-A sequence. The length of poly-A should be about 15-mers. In the sample amplification process, we should consider adding a poly-T tail to the analytes sequences. So even multiple products were obtained after the amplification, all of analytes are with a poly-T tails. Thus, they can hybridize with the poly-A-labels and make the sandwich strands.

Another alternative is using a special antibody which binds with double strands only. After hybridization, this labeled antibody would bind with the perfect matched double strands. This can be a good solution for multiplex labeling reaction. Under this condition, the working electrode may could be increased.

For protein binding assays, especially for Ab-Ag bindings, this label molecule can be linked with Abs via —NHS-ester and —NH2 reaction.

Additionally, the diagnostics apparatus of this invention is utilized for DNA/RNA testing in alternative embodiments, which supports translational medicine and can be advantageously applied in the context of personalized companion diagnostics.

We claim:

1. An electrochemiluminescence (ECL) analytical apparatus for high-throughput multi-analyte testing, comprising a multi-well plate, wherein a microarray of working electrodes is placed in each well, wherein said microarray of working electrodes connects with a counter electrode thereby forming a two-electrode electrochemical system; wherein each well of said multi-well plate is electrically addressable, thereby controlling ECL reactions in flexible modes; wherein carbon paste is employed for the multi-well plate as one of the electrode material, the electric contact material, and the print circuit material;
and wherein the carbon paste for said working electrode comprises a level of streptavidin.

2. The apparatus of claim 1, wherein the carbon paste for said counter electrode excludes any level of streptavidin.

3. The apparatus of claim 2, wherein the carbon paste for said working electrode comprises about 1-10% of streptavidin by weight.

4. The apparatus of claim 3, wherein the carbon paste for said working electrode comprises about 5% of streptavidin by weight.

5. The apparatus of claim 4, wherein said multi-well plate is 96 or more well plate.

6. The apparatus of claim 5, further comprising a detector where ECL signals are detected.

7. The apparatus of claim 6, wherein said detector comprises a CCD-chip assembling matrix.

8. The apparatus of claim 7, wherein said detector is based on proximity detection, and wherein no other optical tools are used.

9. The apparatus of claim 8, further comprising a liquid fluidic system for labeling and washing, and a data management system for reporting and analyzing data signals from said detector.

10. The apparatus of claim 9, wherein said data management system is one of software, hardware, and firmware.
